(19) United States
(12) Patent Application Publication
(10) Pub. No.: US 2018/0157040 A1
(43) Pub. Date: Jun. 7, 2018

(54) DISPLAY DEVICE FOR A MOTOR VEHICLE

(71) Applicants: ALEXANDER VAN LAACK, AACHEN (DE); FREDERIK BELZL, KOLN (DE); RUDDY CITTADINI, KOLN (DE)

(72) Inventors: ALEXANDER VAN LAACK, AACHEN (DE); FREDERIK BELZL, KOLN (DE); RUDDY CITTADINI, KOLN (DE)

(21) Appl. No.: 15/827,240

(22) Filed: Nov. 30, 2017

(30) Foreign Application Priority Data
Dec. 1, 2016 (DE) 10 2016 123 257.2

(51) Int. Cl. G02B 27/01; G02B 27/02; G02B 5/32; G06F 3/14; B60K 37/02

(52) U.S. Cl. CPC G02B 27/0103; G02B 27/026; B60K 2350/2095; G06F 3/1446; B60K 37/02; G02B 5/32

(57) ABSTRACT

A display device for a motor vehicle includes a first display unit oriented horizontally and presenting first image information toward a second display unit, which is oriented at an acute angle of preferably 45° from the first display unit. The second display unit provides second image information from an interior surface directed toward the first display unit. A combiner including a semi-transparent mirror is disposed on the interior surface of the second display unit for merging the first image information together with the second image information. In this way, the first image information and the second image information can be represented simultaneously, with the second image information represented in a plane closer to the observer than the first image information. The display device therefore displays second image information in the form of a text or image such as a warning, overlying image information such as from a navigation system.

### CROSS REFERENCE TO RELATED APPLICATION

This U.S. utility patent application claims the benefit of German patent application No, 10 2016 123 257.2, filed Dec. 1, 2016, the contents of which are incorporated herein by reference in its entirety.

### BACKGROUND

For reasons such as improving operator interface, and for space reasons, automobile manufacturers seek to design displays or display devices such that more content, information or image information can be represented graphically. For this purpose, the aim is to be able to represent image information in the display device in different planes perceived by an observer at different depths or at different distances.

Currently, no such display devices exist, which, for example, can work with holographic display technology and can be implemented in a vehicle. Therefore, there is a need for such a display device, which, in addition to representing information in several planes, for example, can also produce a 3D visualization in one module.

DE 10 2008 023 839 A1 discloses a display unit for a motor vehicle, which comprises a first display device for displaying first information in an approximately vertical first display plane which can be observed directly by a vehicle driver through a semi-transparent mirror. The display unit also comprises a second display device for displaying second information in a second display plane which, in its operating position, is inclined relative to the first display plane by an angle of 90°. The second display device is arranged on the vehicle driver side in front of and below the first display device, wherein the second information can be reflected by a semi-transparent mirror toward the vehicle driver. The second display device is arranged so that it can be moved from its operating position toward the semi-transparent mirror in an out-of-operation position. In addition, the semi-transparent mirror is arranged so that it substantially halves the angle between the first display plane and the second display plane. Different types of display devices are disclosed including a liquid crystal display and/or an LED display.

DE 103 33 745 A1 discloses a display device for a motor vehicle, in particular a combination instrument, with at least one first display device which outputs imaging light and at least one illuminated and/or self-illuminated electromechanical second display device, in particular at least one pointer instrument. The first display device is arranged in a viewing field of a vehicle driver. The first display device and the second electromechanical display device are arranged at an angle with respect to one another. This angle is preferably selected in a range between 75° to 120°, wherein an angle of 90° is indicated as particularly advantageous. In addition, between the first display device and the electromechanical second display device, a combiner is provided, which is transparent to the imaging light of the first display device and designed to be reflective for the imaging light of the electromechanical second display device. According to the description, the first display device, which can be a liquid crystal display, an OLED display or any other display device of this type, is arranged in the viewing field of the vehicle driver. The second electromechanical display device, which comprises display elements of a conventional combination instrument, such as circular instruments for speed display, is arranged at an angle relative to the first display device outside of the viewing field of the vehicle driver. A combiner is arranged between the first display device and the electromechanical second display device, such that it combines the imaging light of the first display device and the electromechanical second display device to form a common display image. The combiner is disclosed as being transparent to the imaging light of the first display device and is configured to reflect the imaging light of the electromechanical second display device.

DE 10 2005 034 096 A1 describes a combination instrument for a motor vehicle with a first display device and a second display device, wherein the combination instrument comprises an image combining device designed, in particular, as a semi-transparent mirror. The image combining device, the first display device and the second display device are arranged with respect to one another in such a manner that, to an observer of the combination instrument, a virtual image of the second display device appears in front of the first display device. The image information to be represented by means of the first display device and/or the second display device is represented with distortion as a function of a distance between the first display device and the virtual image of the second device, or of a distance between the first display device and the observer of the combination instrument or a usual position of the observer of the combination instrument, and/or of a distance between the virtual image of the second display device and the observer of the combination instrument or a usual position of the observer of the combination instrument. By means of this form of representation of which the amount of distortion can be adjusted, the readability of the information of the display device is to be improved. The first display device and the second display device are arranged substantially orthogonally with respect to one another. The semi-transparent mirror is inclined by approximately 45° both with respect to the first display device and also with respect to the second display device.

The arrangements of the display devices known from the prior art require relatively large installation space to accommodate a second display. Their manufacture can be cost intensive, and they may exhibit a relatively low quality image.

### SUMMARY

An aim of the invention is to provide a display device for a motor vehicle, producing representations of image information in different planes and which minimizes the space required for installation.

The present disclosure provides a display device in the form of a module used in a vehicle, which enables representing a virtual 3D view of information, in particular a display unit representing a speed or a rotation speed, in connection with information of a navigation system or other contents.

In order to be able to represent different information or image information in planes or layers which are separate from one another, two display units and a combiner are used in the present invention. Such a combiner has the property of being reflective for light that is on the combiner from a first side and of being transparent for a light that is incident on the combiner from a second side. The combiner may be, for example, a semi-transparent mirror.

In the present invention, for example, the first image information represented or the light emitted by a first display unit is reflected by the combiner.

By using a combiner to merge images from two displays representing different content, the installation space needed for the display device is clearly reduced. This reduction or the space gain to be achieved is an important factor in automobile development and automobile manufacture.

By means of such display devices, it is possible to represent image information arranged in stacks layered on top of one another or arranged spatially one behind the other. This arrangement can be used, for example, for displaying important information of higher priority in a layer facing the observer, that is spatially above or in front of other represented information, images and graphics.

By means of such a display device, it is possible to show warnings in the display device in a separate information layer over currently displayed content. A separate display for this warning message, that is to say an additional complex system, is therefore no longer needed.

In addition, a second display unit for representing second information is arranged in the display device. The second display unit is arranged at an acute angle or inclination with its light-emitting surface at an angle of preferably 45° with respect to the also light-emitting surface of the first display device. The first display device is preferably arranged oriented horizontally.

Here, the information to be prioritized is represented or projected by the second display forming the uppermost layer or plane in the display device. Thus, this information can include other information or representations in an underlying layer or plane, which is are generated by the first display.

According to a development of the invention, a corner of the second display unit is oriented parallel to a corner of the first display unit, wherein the corners, for reasons pertaining to the reduction of the installation space are arranged in close proximity to one another. Such corners are understood to refer to the parallel corners of the first and second display units, which are advantageously of rectangular or square design, and which are arranged in the area of the vertex of the angle between the light-emitting surfaces of the first and of the second display unit.

It is particularly advantageous to arrange the combiner on the light-emitting surface of the second display unit in such a manner that the first image information of the first display unit is reflected by the combiner, while the second image information of the second display unit penetrates through the combiner.

In this way an observer, in particular the vehicle driver, can perceive the first image information of the first display unit, for example, in a virtual plane. Simultaneously, the observer can perceive the second image information in a second plane separate from the virtual plane. From the viewing direction of the observer looking at the display device, the second image information appears to be located above the first image information. The second image information thus appears to be at a smaller distance from the observer than the first image information represented in the virtual plane.

For the first display unit and/or the second display unit, an LED display, an LCD display or an OLED display can be used, for example. For the second display unit, in addition, an LED matrix, a segment display or similar arrangements can also be used, which are capable of representing image information.

According to an advantageous design of the invention, the second display unit such as, for example, an LED matrix, is firmly connected to the combiner by optical bonding. Thus, the second display unit is connected directly to the semi-transparent mirror.

In optical bonding, for example, a space between the surface of the second display unit and of the combiner is filled with a composition having an adapted refraction index, in order to connect the structural components to one another. This air-free filling of the gap makes it possible to manufacture displays with good optical properties and an improved contrast ratio.

If a user or observer such as, for example, the driver of a motor vehicle, is looking at the display device or into the display device as vehicle driver, he/she can recognize the first image information in the virtual plane. This can be, for example, information of a navigation system or of any other system of the vehicle.

When the second display unit is connected additionally and second image information is generated, said image information, to the observer, is represented arranged above the first image information. Thus, for example, additional information such as a warning message can be shown, which appears above the image information of a navigation system. When viewing the display device, the observer has a three-dimensional impression. This effect is by the inclined position of the second display unit, which is inclined at an acute angle such as, for example, between 40 and 50° relative to the first display unit.

The display device according to the invention offers a compact design for a display device and requires less installation space than the display devices known from the prior art with two display units or displays for representing two different image information items. By means of the special arrangement of the surfaces of the display units at an angle of 45°, for example, with respect to one another, and by means of the direct connection of the second display unit to the combiner, the space behind the second display unit, viewed in the viewing direction of an observer, can be used for electronic modules or printed circuit boards, such as, for example, modules for actuating the two display units or the electronics of a communication interface of the display device.

### BRIEF DESCRIPTION OF THE DRAWINGS

Further details, features and advantages of designs of the invention result from the following description of embodiment examples in reference to the associated drawings.

FIG. 1 shows a schematic diagram of a first design of the display device according to the invention,

FIG. 2 shows a schematic diagram of an alternative design of the display device according to the invention,

FIG. 3 shows a perspective representation of the display device according to the invention, and

FIG. 4 shows an exemplary representation in two different planes of information generated by the display device according to the invention.

### DETAILED DESCRIPTION

Recurring features are marked with identical reference numerals in the figures.

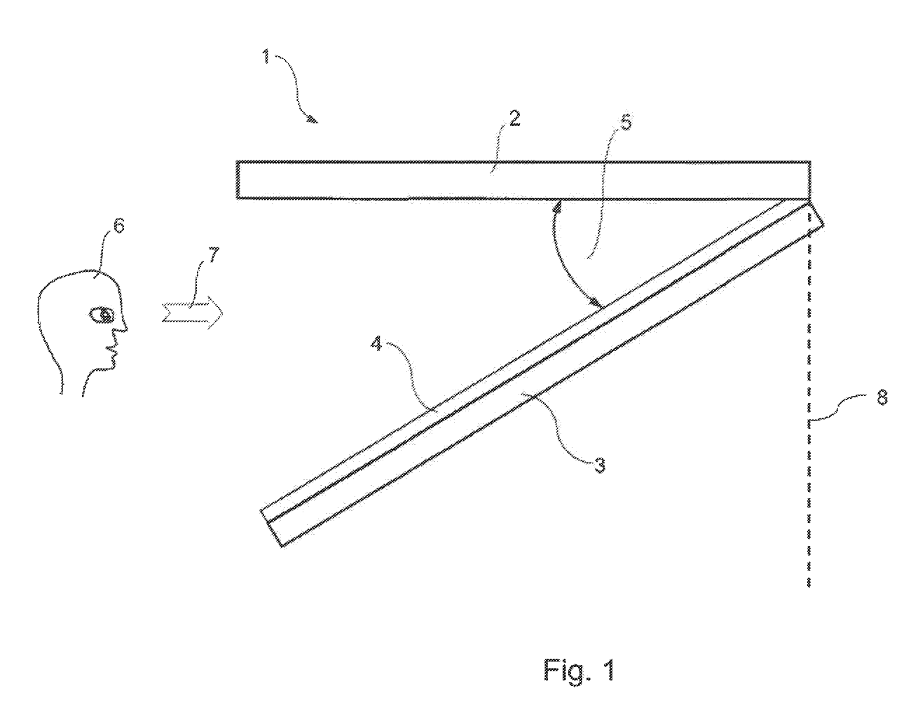

In FIG. 1, a first design of the display device 1 according to the invention is represented. The display device 1 comprises a first display unit 2 which is arranged, for example, oriented horizontally. The display device 1 also has a second display unit 3 which is oriented at an acute angle 5 of 45°, for example, relative to the first display unit 2 and arranged under the first display unit 2. The first display unit 2 represents the first image information on the surface oriented toward the second display unit 3. The second image information of the second display unit 3 is provided on its interior surface directed toward the first display unit 2.

The first and the second image information generated by the first display unit 2 and the second display unit 3 can contain, for example, sips, numbers, symbols, images or videos.

A combiner 4 is disposed on the interior surface of the second display unit 3, and oriented toward the first display unit 2. The combiner 4 may be, for example a semi-transparent mirror. For the first image information provided by the first display unit 2, the surface of the combiner 4 is reflecting, so that an observer 6 looking at the display device 1 in a viewing direction 7 perceives the first image information of the first display unit 2 in a virtual plane 8, for example, as a virtual image.

For the representation of the second image information for the observer 6, the combiner 4 is transparent to the light emitted by the surface of the second display unit 3 or the second image information thereof.

The first image information generated with the first display unit 2 and the second image information generated with the second display unit 3 can be merged or represented simultaneously. For example, the second image information generated by the second display unit 3 may be represented in a plane closer to the observer 6 than the first image information generated by the first display unit 2.

In this way it becomes possible to display second image information provided in the form of a text or image by the second display unit 3, for example, a warning, over image information, for example, of a navigation system, which is generated by means of a first display unit 2. The first image information of the navigation system is not changed by the overlaying of the second image information and can be recognized by an observer in a plane below the second image information.

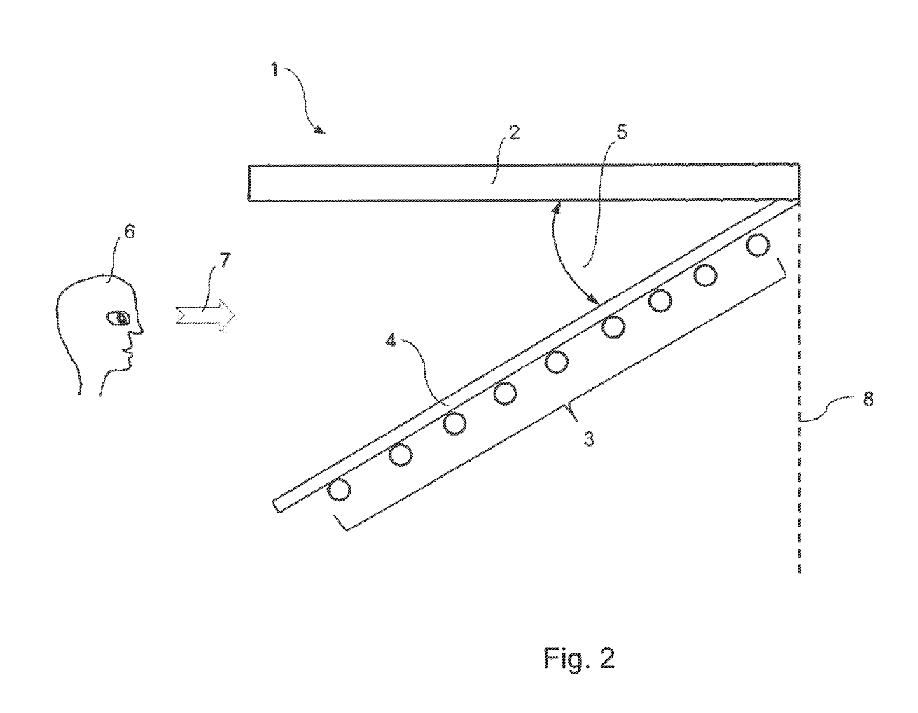

In FIG. 2, an alternative design of the display device according to the invention for representing multiple image information items is represented. Under the first display unit 2, which is oriented horizontally, for example, the combiner 4 is arranged at an angle of approximately 45°. In contrast to FIG. 1, the second display unit 3 is designed as an LED matrix, for example. The design of the second display unit 3 as a simplified, optionally only single-colored, LED matrix or as a display in the form of one or more segment displays, such as a seven, fourteen or sixteen segment display, leads to a reduction of the costs of the display device 1, since no full-featured display is necessary.

In general, both for the first display unit 2 and also for the second display unit 3, preferably rectangular or square displays, such as, for example, an LED display, English “light-emitting diode” abbreviated LED, an LCD display, English “liquid crystal display” abbreviated LCD, or an organic light emitting diode-using OLED display, English “organic light emitting diode” abbreviated ° LED, can be used.

For the second display unit 3, an LED matrix or any segment displays such as, for example, a seven, fourteen, or sixteen segment display, can be used, without any limitation to the shapes of display elements.

In this design as well, for an observer 6 of the display device 1, the second image information is represented as hovering in another image plane above the first image information.

The design of the invention in the form such that the first display unit 2 is oriented horizontally is very advantageous but not absolutely required. The first display unit 2 can also be oriented vertically. Here, it is only necessary that the first as well as the second image information are provided rotated by 90°, so that they appear correctly or readably to an observer 6 of the display device 1.

Such an orientation of the display device 1 can be advantageous, for example, in the case of installation of the display device 1 in an area in the center of a dashboard or in the area of the center console. In this case, the second image information, which may be intended on a priority basis for the vehicle driver as observer 6, is represented in a manner so that it is oriented toward the vehicle driver 6 and is therefore particularly easily recognizable from the position of the vehicle driver 6 in the viewing direction 7.

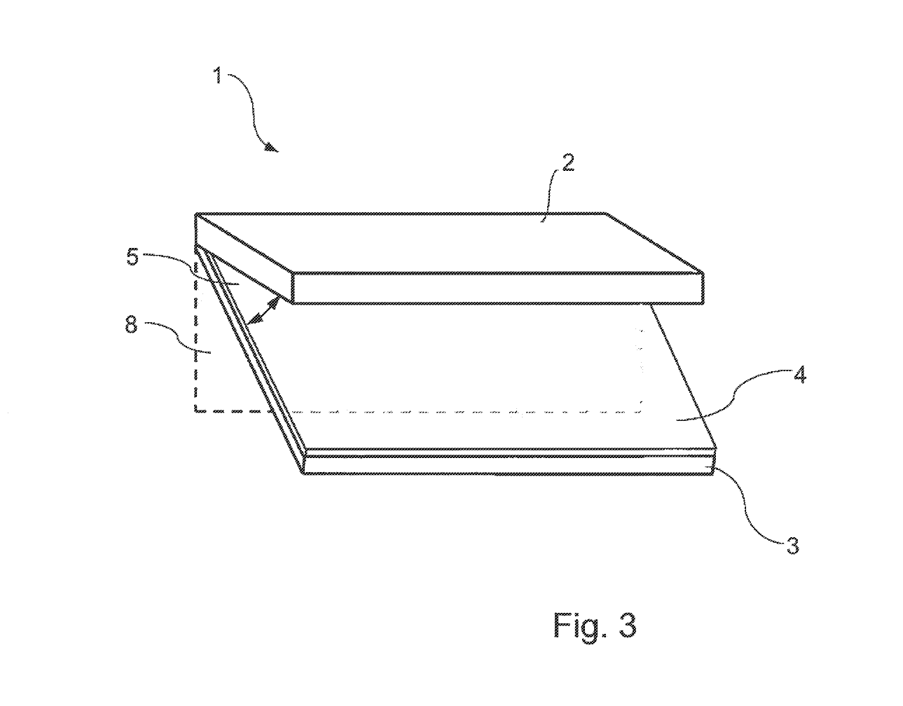

In FIG. 3, a perspective representation of the display device 1 according to the invention is shown. The orientation of the display device 1 in FIG. 3 corresponds approximately to the viewing direction 7 of an observer 6 of the display device 1.

The first display device 2 is oriented horizontally and arranged above the second display unit 3 and the combiner 4. The second display unit 3 and the combiner 4 are connected to one another, for example, by optical bonding, and are arranged rotated around an axis by an angle of approximately 45° relative to the first display unit 2. If an observer 6 is looking into the display device 1, then his/her gaze falls on the reflecting surface of the combiner 4, on which the first image information generated by the first display unit 2 is represented. The observer 6 perceives the first image information as an image which to him/her appears to be represented in a virtual plane 8.

If, in addition to the representation of the first image information, second image information is provided by means of the second display unit 3, then said second image information appears through the combiner 4 and is perceived by the observer 6. The observer 6 sees the position of the second image information in a plane above the representation of the first image information.

In FIGS. 1 to 3, the display device 1 is represented only with the components necessary for the explanation of the mode of operation. It is understood that the display device 1 is installed in a correspondingly suitable housing and has, for example, a front plate which forms the front closure of the housing. The description and representation of the actuation electronics necessary for the display units 2, 3 have also been dispensed with.

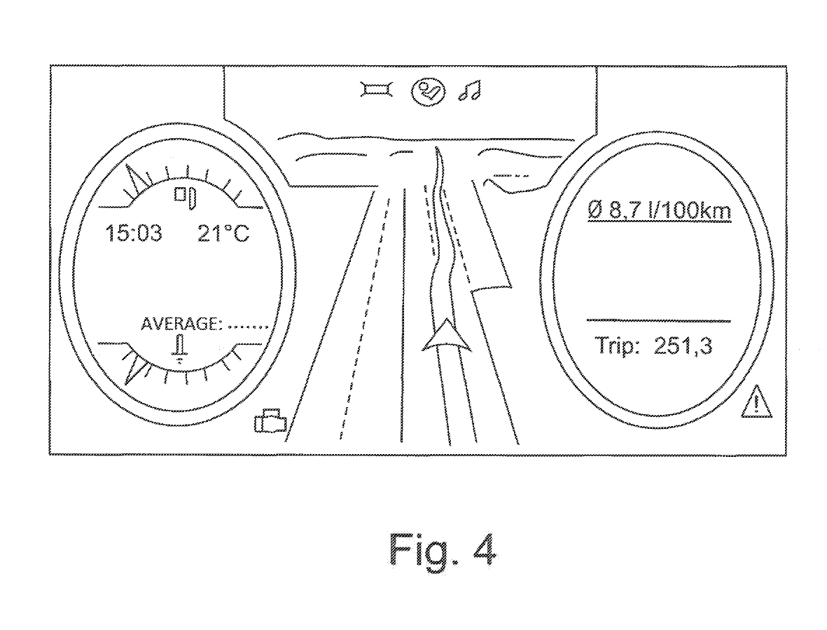

In FIG. 4, an exemplary representation of image information generated with the display device 1 according to the invention is shown in two different planes.

In a first image plane, the representation shows the first image information which, in the example, represents information of a navigation system of a vehicle for route guidance. In a second image plane, image information can be represented, which, in addition to status and/or warning messages, can also consist of conventional representations of combination instruments for displaying the speed, the fuel reservoir level, the number of kilometers, the motor rotation speed, the coolant temperature, the cruising range, the gearbox setting and much more additional information on the vehicle status.

Obviously, many modifications and variations of the present invention are possible in light of the above teachings and may be practiced otherwise than as specifically described while within the scope of the appended claims.

What is claimed is:

1. A display device for a motor vehicle comprising:
a first display unit for representing first image information;
a second display unit oriented at an acute angle relative to the first display unit and defining an interior surface facing the first display unit; and
a combiner disposed on the interior surface of the second display unit.

2. The display device according to claim 1, wherein the first display unit defines a first surface facing the second display unit and extending to a first corner at a vertex of the acute angle;
wherein the interior surface of the second display unit extends to a second corner at the vertex of the acute angle; and
wherein the corners are parallel to one another.

3. The display device according to claim 1, wherein the first display unit is an LED display, an LCD display or an OLED display.

4. The display device according to claim 1, wherein the second display unit is an LED display, an LCD display, an OLED display, an LED matrix or a segment display.

5. The display device according to claim 1, wherein the acute angle is between 40° to 50°.

6. The display device according to claim 5, wherein the acute angle is 45°.

7. The display device according to claim 1, wherein the combiner is a semi-transparent mirror.

8. The display device according claim 1, wherein the combiner is firmly connected to the second display unit by optical bonding on the interior surface of the second display unit.

9. The display device according to claim 1, wherein the first display unit is oriented horizontally.
